(19) United States
(12) Patent Application Publication
(10) Pub. No.: US 2006/0192975 A1
(43) Pub. Date: Aug. 31, 2006

(54) Surface shape measuring apparatus

(75) Inventors: Yasuhiro Sato, Kanagawa (JP); Makoto Furuki, Kanagawa (JP); Izumi Iwasa, Kanagawa (JP); Satoshi Tatsuura, Kanagawa (JP); Minquan Tian, Kanagawa (JP); Hiroyuki Mitsu, Tokyo (JP); Takashi Matsubara, Kanagawa (JP)

Correspondence Address: OLIFF & BERRIDGE, P.O. BOX 19928, ALEXANDRIA, VA, 22320, US

(73) Assignee: FUJI XEROX CO., LTD., Tokyo (JP)

(21) Appl. No.: 11/176,206

(22) Filed: Jul. 8, 2005

(30) Foreign Application Priority Data
Feb. 28, 2005 (JP) 2005-054222

(51) Int. Cl. G01B 11/02

(52) U.S. Cl. 356/497; 356/516

(57) ABSTRACT

A surface shape measuring adapted so that object light and reference light are outputted from a low coherence light source, the object light which is irradiated onto an object and is reflected and returned therefrom is combined with the reference light, combined light is received by a photodetector to measure a surface shape of the object, including: an optical path length scanning portion adapted to scan an optical path length of the object light or the reference light within a predetermined range; and a splitting optical system provided on at least one of optical paths of the object light and the reference light, to split an incident light beam into light beams, wherein the splitting optical system sets a predetermined optical path length difference corresponding to each predetermined pair of the light beams among the light beams into which the incident light beam is split.

### BACKGROUND OF THE INVENTION

1. Field of the Invention

The present invention relates to a surface shape measuring apparatus adapted to measure the shape of a measurement object by irradiating light to the measurement object and receiving light reflected from the measurement object and measuring a distance to the measurement object.

2. Background Art

A method of measuring an object by using light has the steps of irradiating light, which is generated from a low temporal coherence light source, to a measurement point on an object and then measuring a traveling time taken by the light reflected on the surface of the object to reach a light receiving surface. Thus, the surface shape of the object can be measured (see, for example, JP-A-11-248412).

When the traveling time is measured, the light generated from the light source is split into two beams, one of which is used as an object light to be irradiated onto the object, and the other of which is used as a reference light serving as the basis of evaluation of the traveling time. The measurement of the traveling time utilizes the fact that an interference signal or a correlation signal can be measured only at a point at which the difference in optical path length between the object light and the reference light is 0.

Thus, the optical path length of the reference light, at which an interference signal or a correlation signal is generated, is evaluated by scanning the optical path length of the reference light while measurement positions on the object are sequentially changed. Consequently, the optical path length of the object light at each of the positions of the object can be measured. The surface shape of the object is determined from the differences in optical path length among object light beams reflected from the measurement positions.

According to the aforementioned surface shape measuring method, a light source of very low temporal coherence is used so as to obtain the traveling time with high precision. For example, a superluminescent diode and an ultrashort light pulse source are used as the low coherence light source.

Thus, measurements of traveling distances respectively corresponding to the measurement points in a measurement plane of the object are sequentially performed by using the aforementioned light source. Consequently, the surface shape of the object can be obtained from differences in traveling distance of the object light among the measurement points with good accuracy.

However, according to the aforementioned surface shape measuring method, the temporal coherence of the light source used for the measurement is low. Thus, the coherent length thereof is short, that is, about tens μm, while the resolution in a depth direction is high. In a case where the measurement object has a large step-like part, the distance in optical path length between the reference light and the object light at one of both sides of the step-like part should be changed to be equal to or less than the coherent length of the light source at the other side of the step-like part. Further, in a case where large step-like parts are consecutively provided in the measurement object, the scanning range of the reference light should be changed each time when the measurement position is changed. Thus, the aforementioned surface shape measuring method has a drawback in that a measurement time taken to measure a surface shape is long. In a case where the measurement time is long, the surface shape of, for instance, an object, whose shape changes sharply, cannot be measured with good accuracy.

### SUMMARY OF THE INVENTION

An object of the invention is to provide a surface shape measuring apparatus that has a high resolution in the depth direction of an object and that is enabled to measure the surface shape of an object, which has a relatively large step-like part, in a short time.

To achieve the foregoing object, according to the invention, there is provided a surface shape measuring apparatus adapted so that object light and reference light are outputted from a same low coherence light source, that after the object light, which is irradiated onto a measurement object and is reflected and returned therefrom, is combined with the reference light, combined light is received by a photodetector to thereby measure a surface shape of the measurement object. This surface shape measuring apparatus comprises an optical path length scanning portion adapted to scan an optical path length of the object light or the reference light within a predetermined range, and a splitting optical system provided on at least one of optical paths of the object light, which comes from the measurement object, and the reference light, to split an incident light beam, which is incident thereon, into plural light beams, and characterized in that the splitting optical system sets a predetermined optical path length difference corresponding to each predetermined pair of the light beams among the plural light beams into which the incident light beam is split.

With this configuration, at least one of the object light and the reference light outputted from the same low coherence light source is split into plural light beams by the splitting optical system. Subsequently, the predetermined optical path length difference is given to between each pair of adjacent light beams among the plural light beams. Thereafter, the plural light beams are combined with the object light or the reference light, which is not split. Then, the combined light is incident on the photodetector. This photodetector outputs an electric signal corresponding to the optical path length difference between the object light and the reference light. The use of the low coherence light source results in reduction in distance at which an interference signal or a correlation signal is generated. Also, the resolution in the depth direction is enhanced. A measuring range is expanded corresponding to the number of light beams into which the incident light is split by the splitting optical system. Thus, a measurable range can be expanded without degrading the resolution. Also, the surface shape of a measurement object having continuous step-like parts can be performed with high resolution in a short measurement time.

Preferably, the surface shape measuring apparatus according to the invention comprises a pair of the splitting optical systems provided on both optical paths of the object light, which comes from the measurement object, and the reference light. One of the pair of splitting optical systems sets a predetermined optical path length difference corresponding to each predetermined pair of the light beams among the plural light beams into which the incident light beam is split. With this configuration, the object light and the reference light, which have the same beam diameter, are combined with each other. Then, the combined light can be detected. Thus, the light utilizing efficiency is enhanced.

Preferably, the splitting optical system comprises an incidence surface and an output surface, which are parallel to each other, plural parallel transparent plates stacked and inclined to each of the incidence surface and the output surface 45 degrees, and a beam splitter surface and a reflection surface, which are formed at predetermined places on stacked surfaces that are provided among the plural parallel transparent plates. With this configuration, the manufacture of the apparatus is facilitated. A high-precision splitting optical system can be manufactured.

Preferably, the one of the pair of splitting optical systems sets the predetermined optical path length difference corresponding to each predetermined pair of the light beams among the plural light beams by adjusting thicknesses of the plural parallel transparent plates. Consequently, an accurate optical path length difference can easily be obtained.

Preferably, the optical system is formed integrally with the combining optical system. Consequently, the position adjustment is facilitated. The miniaturization of the optical system can be achieved. Also, fluctuation of the level of an output signal of the photodetector, which is caused due to vibrations, can be reduced. Further, the S/N ratio can be improved.

Preferably, the photodetector has plural photoelectric conversion devices of the number corresponding to the number of the light beams, into which the incident light beam is split by the splitting optical system. Each of the plural photoelectric conversion devices converts the combined light, which is received by the photodetector, into an electrical signal corresponding to the optical path length difference between the object light and the reference light. With this configuration, electric signals can be obtained from the photoelectric conversion devices independent of one another.

Preferably, when the object light interferes with the reference light, the photodetector outputs an interference signal corresponding to an interference intensity. According to the interference method, it is sufficient to have only a detection device adapted to output interference signals. Thus, the configuration can be simplified. Also, even in the case of weak light, the interference intensity can be detected.

Generally, a superluminescent diode, whose coherence length is about tens μm, is used as the low coherence light source. To obtain a high spatial resolution of several μm, it is preferable to use a pulsed light source adapted to output ultrashort light pulse. An interference range or a correlation range is narrowed. Consequently, a highly accurate measurement can be achieved.

A device adapted to output a correlation signal corresponding to an optical path length difference between the object light and the reference light can be used. In this case, the correlation signal can be obtained by using a nonlinear optical device adapted to wavelength-convert the combined light to second harmonics and to cause the harmonics to be incident on the photoedetector, a photodetector adapted to output two-photon induced current excited by two-photon, and a Kerr shutter adapted to open in response to reference light and to cause the object light to be incident on the photodetector. According to such a correlation method, the apparatus is less subjected to disturbances, such as vibrations. Thus, a stable measurement is enabled.

According to the surface shape measuring apparatus according to the invention, the surface shape of a measurement object, which has a relatively large step-like part, can be measured in a short time with high resolution in the depth direction.

### BRIEF DESCRIPTION OF THE DRAWINGS

These and other objects and advantages of this invention will become more fully apparent from the following detailed description taken with the accompanying drawings in which:

FIG. 1 is a diagram illustrating the configuration of a surface shape measuring apparatus according to a first embodiment of the invention;

FIG. 2 is a diagram illustrating the detailed configurations of first and second lightwave splitting devices;

FIGS. 3A and 3B illustrates timing with which each of plural object light beams and plural reference light beams is received in the first embodiment of the invention; FIG. 3A is a timing chart illustrating the measurement of a surface region (1) of a measurement object; and FIG. 3B is a timing chart illustrating the measurement of a surface region (2) of the measurement object;

FIG. 4 is a diagram illustrating the configuration of a surface shape measuring apparatus according to a second embodiment of the invention;

FIG. 5 is a diagram illustrating the configuration of a primary part of a surface shape measuring apparatus according to a third embodiment of the invention;

FIG. 6 is a diagram illustrating the configuration of a primary part of a surface shape measuring apparatus according to a fourth embodiment of the invention;

FIG. 7 is a diagram illustrating the configuration of a surface shape measuring apparatus according to a fifth embodiment of the invention;

FIG. 8 is a diagram illustrating the configuration of a surface shape measuring apparatus according to a sixth embodiment of the invention;

FIG. 9 is a diagram illustrating the configuration of a surface shape measuring apparatus according to a seventh embodiment of the invention;

FIG. 10 is a diagram illustrating the configuration of a surface shape measuring apparatus according to an eighth embodiment of the invention; and

FIGS. 11A and 11B illustrates timing with which each of plural object light beams and a single reference light beam is received in the eighth embodiment of the invention; FIG. 11A is a timing chart illustrating the measurement of the surface region (1) of a measurement object; and FIG. 11B is a timing chart illustrating the measurement of the surface region (2) of the measurement object.

### DETAILED DESCRIPTION OF THE PREFERRED EMBODIMENTS

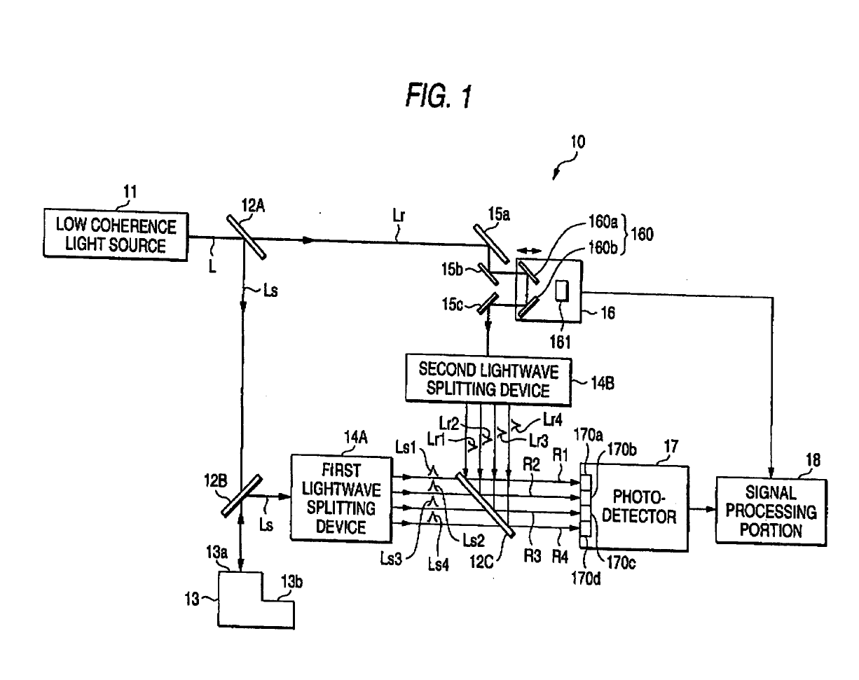

FIG. 1 shows the configuration of a surface shape measuring apparatus according to a first embodiment of the invention. This surface shape measuring apparatus 10 has a low coherence light source 11, which has a short coherent length and is adapted to output light pulses L, and a first beam splitter 12A serving as a splitting optical system for splitting a light pulse L, which is outputted from the low coherence light source 11, into object light Ls and reference light Lr.

Also, a second beam splitter 12B, which reflects object light Ls irradiated from the first beam splitter 12A and reflected from the surface of the measurement object 13 towards a photodetector 17 (to be described later), and a first lightwave splitting device 14A, which serves as a splitting optical system adapted to split the object light Ls reflected by the second beam splitter 12B into four parallel object light beams Ls1 to Ls4 in one dimension, are disposed on the optical path of the object light Ls.

Also, an optical path length scanning portion 16 adapted to scan the reference light Lr, which is outputted from the first beam splitter 12A through reflection mirrors 15a and 15b, in a predetermined range is disposed on the optical path of the reference light Lr, together with a second lightwave splitting device 14B adapted to split the reference light Lr, which is scanned by the optical path length portion 16 and is introduced thereto through the reflection mirror 15c, into four parallel reference light beams Lr1 to Lr4 and to serve as a splitting optical system that sets a predetermined optical path length difference among the reference light beams Lr1 to Lr4.

The surface shape measuring apparatus 10 has a third beam splitter 12c serving as a wave combining optical system adapted to respectively combine the four object light beams Ls1 to Ls4, which are outputted from the first lightwave splitting device 14A, with the four reference light beams Lr1 to Lr4, which are outputted from the second lightwave splitting device 14B, and also has a photodetector 17, which receives the combined light obtained by the third beam splitter 12C and converts the received light to an electrical signal corresponding to an optical path difference between the object light and the reference light, and a signal processing portion 18 adapted to obtain distance information representing a distance to the surface of the measurement object 13 according to the electrical signal received from the photodetector 17.

Next, each component of this apparatus 10 is described in detail hereinbelow.

Pulsed light sources, such as a mode-locked titanium sapphire laser, and an erbium-doped or ytterbium-doped mode-locked fiber laser, can be used as the low coherence light source 11. Incidentally, any light sources other than the pulsed light sources can be applied to the surface shape measuring apparatus of the invention, as long as the coherence lengths of the light sources are short. For example, superluminescent diodes, multimode edge-emitting semiconductor lasers, and multimode surface-emitting lasers may be used.

The optical path length scanning portion 16 has a movable portion 160, which comprises a pair of reflection mirrors 160a and 160b that reflect the introduced reference light Lr, and also has a driving portion 161 that is provided with a piezoelectric device and a motor, which drive the movable portion 160, and that outputs a position signal representing the position of the movable portion 160. Thus, high-precision scanning can be achieved by maintaining the parallelism of the incidence light beams and the output light beams. Preferably, the scanning resolution of the movable portion 160 is set to be less than a value converted to a distance by multiplying the pulse width of the light source 11 by the light propagation speed (3×10⁸ m/s). For instance, in a case where light pulses L, the pulse duration (that is, the full width at half maximum) of each of which is about 100 fs, are used, this pulse duration is converted to a distance that is 30 μm. An amount of change in the optical path length is twice the scanning amount of the movable portion 160. Thus, the scanning resolution of the movable 160 is set to be equal to or less than 15 μm. The optical path length scanning portion 16 is also used for adjusting the optical lengths of the reference light Lr and the object light Ls to be nearly equal to each other.

The photodetector 17 is configured by arranging four photoelectric conversion devices 170a to 170d in a one-dimensional array so as to receive four combined light beams, which are produced by combining the four object light beams Ls1 to Ls4 with the four reference light beams Lr1 to Lr4, respectively, independent of one another. Each of the four photoelectric conversion devices 170a to 170d outputs an electric signal corresponding to the optical path length difference between the object light and the reference light. That is, when the optical path length difference between the object light and the reference light is almost 0, the object light interferes with the reference light. Then, each of the four photoelectric conversion devices 170a to 170d outputs an interference signal corresponding to the intensity of interference light. Incidentally, the photodetector 17 may be a planar photoelectric conversion device, such as a CCD camera, which can process signals outputted from pixels to which plural combined light beams are irradiated, independent of one another.

Lightwave Splitting Device

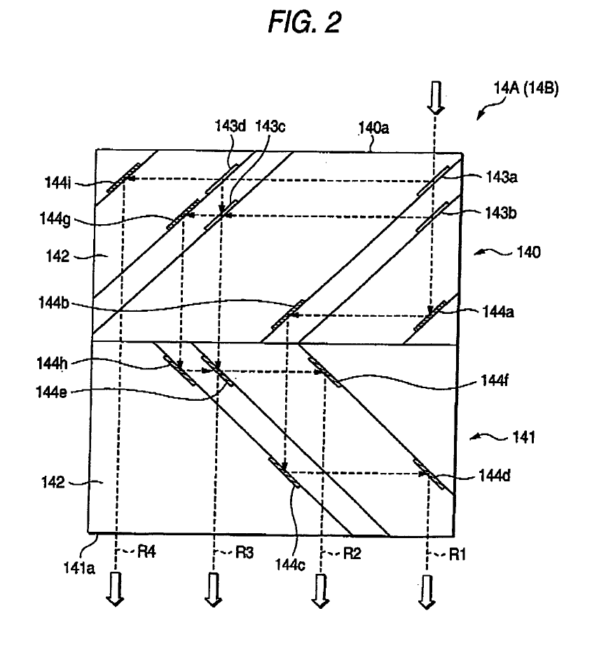

FIG. 2 shows the detailed configurations of first and second lightwave splitting devices 14A and 14B. Lightwave splitting prisms disclosed in JP-A-2004-212979 maybe used as the lightwave splitting devices 14A and 14B. That is, each of the lightwave splitting devices 14A and 14B comprises a first block 140, which has an incidence end surface 140a, and a second block 141 that has an output end surface 141a and is bonded to the first block 140 so that this output end surface 140a is parallel to the second block 141.

Each of the first and second blocks 140 and 141 is formed like a substantially rectangular solid by stacking plural plate-like transparent media 142. Half mirrors 143a to 143d and total reflection mirrors 144a, 144b, 144g, and 144i are disposed in the first block 140 at appropriate positions, while total reflection mirrors 144d, 144e, 144f, and 144h are disposed in the second block 141 at appropriate positions. Light beams impinging upon the incidence end surface 140a of the first block 140 are transmitted or reflected by the half mirrors 143a to 143d. Thereafter, the light beams are reflected by the total reflection mirrors 144a to 144i. Then, the light beams are outputted from the output end surface 141a of the second block 141 to the first to fourth optical paths in a split manner.

In the lightwave splitting device configured as described above, the thickness of each of the transparent media 142 is adjusted to a predetermined value. Thus, timing, with which each of the four object light beams Ls1 to Ls4 is outputted from the output end surface 141a, can be controlled.

That is, the thickness of each of the transparent media 142 is adjusted so that the optical path lengths of the four light beams are equal to one another in the lightwave splitting device. Consequently, the first lightwave splitting device 14A is configured so that the four object light beams Ls1 to Ls4 are outputted at the same time.

Also, the thickness of each of the transparent media 142 is adjusted so that an optical path length difference is caused among the four light beams in the lightwave splitting device. Consequently, the second lightwave splitting device 14B is configured so that the four reference light beams Lr1 to Lr4 differ from one another in the timing with which the light beam is outputted therefrom. In this embodiment, an optical path length difference of 1 ps (incidentally, a propagation distance in the air, to which this optical path length difference is converted, is 300 μm) is set corresponding to each of pairs of the adjacent light beams of the four light beams. Thus, an irregular surface shape of the measurement object 13 can continuously be measured by setting the scanning distance of the optical path length scanning portion 16 at 150 μm, which is equivalent to an optical path length of 300 μm.

Incidentally, the number of light beams, to which the reference or object light is split, is not limited to 4. The reference or object light can be split to beams of a given number. For example, a lightwave splitting device, which splits incident light into 16 beams in a two-dimensional manner, can simply be configured by combining the aforementioned two lightwave splitting devices each adapted to split light into four beams in a one-dimensional manner.

Signal Processing Portion

The signal processing portion 18 specifies which of the photoelectric conversion devices 170a to 170d of the photodetector 17 outputs an interference signal. Then, the signal processing portion 18 obtains information representing the optical path length of the reference light, which is a distance to the measurement object 13, according to a position signal outputted from the optical path length scanning portion 16 when the interference signal reaches a peak level. That is, the signal processing portion 18 obtains information representing the optical path length of the object light.

### Operation of First Embodiment

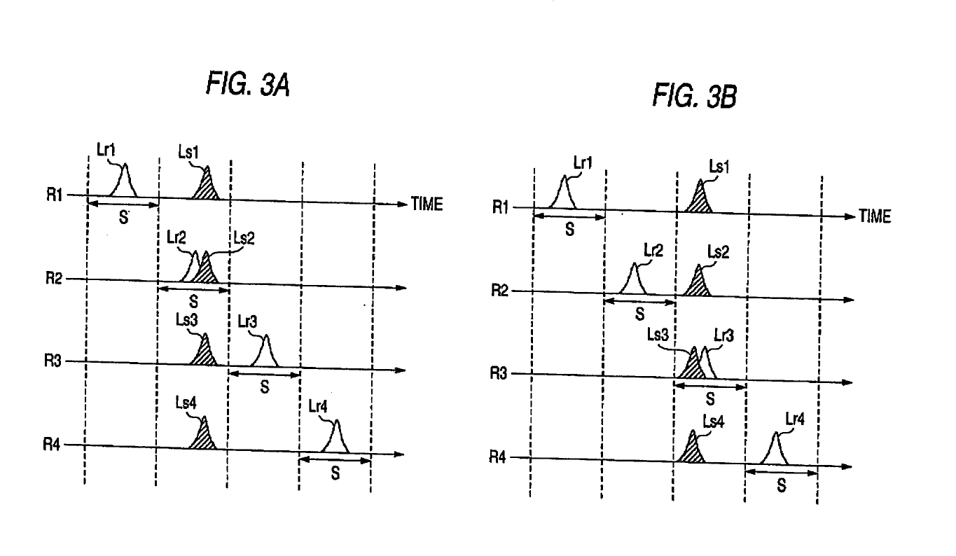

Next, an operation of the first embodiment is described with reference to FIGS. 3A and 3B. FIGS. 3A and 3B are timing charts illustrates timing with which each of plural object light beams and plural reference light beams combined by the third beam splitter 12C is received in the first embodiment. Incidentally, in these figures, reference character “S” designates a scanning range in which the optical path length scanning portion 16 scans.

When a light pulse L is outputted from the low coherence light source 11, the light pulse L is branched to object light Ls and reference light Lr by the first beam splitter 12A. The object light Ls is transmitted by the second beam splitter 12B and is irradiated to the measurement object 13. Then, the object light Ls is reflected on the surface of the measurement object 13. Subsequently, a part of the object light Ls is reflected by the second beam splitter 12B. Thus, the reflected light Ls is incident on the first lightwave splitting device 14A and is split by the first lightwave splitting device 14A into four object light beams Ls1 to Ls4 that are incident on the third beam splitter 12C.

On the other hand, the reference light Lr outputted from the first beam splitter 12A is incident on the second lightwave splitting device 14B after the optical path length scanning portion 16 scans the predetermined optical path length. Then, the reference light Lr is split by the second lightwave splitting device 14B into four object light beams Lr1 to Lr4 so that a predetermined optical path length difference is set corresponding to each pair of adjacent two of the four object light beams. Subsequently, the object light beams Lr1 to Lr4 are incident on the third beam splitter 12C.

The object light beams Ls1 to Ls4 outputted from the first lightwave splitting device 14A are combined with the reference light beams Lr1 to Lr4, respectively, by the third beam splitter 12C. Then, the combined light beams are incident on the photoelectric conversion devices 170a to 170d of the photodetector 17.

In the first lightwave splitting device 14A, four optical paths are equal to one another in optical path length. Thus, all the four object light beams Ls1 to Ls4, to which the object light is split by the first lightwave splitting device 14A, propagate on the four optical paths with the same timing.

On the other hand, because an optical path length difference corresponding to a time difference of 1 ps is set corresponding to each pair of adjacent two of the four optical paths in the second lightwave splitting device 14B, the four reference light beams Lr1 to Lr4 propagate thereon with different timings, respectively.

Therefore, in a case where a surface region (1) of a convex portion of the measurement object 13 is measured by using the object light 13, and where interference between the object light beam and the reference light beam occurs only on the second optical path R2 as shown in FIG. 3A, only the photoelectric conversion device 170b of the photodetector 17, which corresponds to the second optical path R2, outputs an interference signal.

The signal processing portion 18 specifies the photoelectric conversion device 170b, which outputs the interference signal. Then, the signal processing portion 18 obtains information representing a distance to the surface region (1) 13a of the convex portion of the measurement object 13, according to a position signal outputted from the optical path length scanning portion 16 when the interference signal outputted from the photoelectric conversion device 170 breaches a peak level.

When an xy table (not shown), on which the measurement object 13 is put, is operated to thereby change the position of the measurement object 13, so that the object light Ls is irradiated onto a surface region (2) 13b of a concave portion, the optical path length of the object light is increased. Thus, a time taken by the object light to reach the photodetector is increased. At that time, in a case where the unevenness of the surface of the measurement object 13 is large, and where the depth of the concave portion is equal to or larger than twice the scanning range “S” of the optical path length scanning portion 16, no interference signal is produced by the photoelectric conversion device corresponding to the second optical path R2, and instead, the photoelectric conversion device 170c corresponding to the third optical path R3 outputs an interference signal, as shown in FIG. 3B.

The signal processing portion 18 specifies the photoelectric conversion device 170c, which outputs the interference signal. Then, the signal processing portion 18 obtains information representing a distance to the surface region (2) 13b of the concave portion of the measurement object 13, according to a position signal outputted from the optical path length scanning portion 16 when the interference signal outputted from the photoelectric conversion device 170c reaches a peak level. Thus, when the measurement position is changed from the convex portion to the concave portion, an interference signal can be obtained corresponding to the optical path differing from the optical path, from which the interference signal is obtained when the shape of the convex portion is measured, without resetting the scanning range of the reference light. For example, in a case where the second optical path R2 is set to be a reference, and where let L₀ (μm) designate the optical path length of the object light at the measurement of the shape of the surface of the convex portion, and let L₁ (μm) denote the optical path length of the object light at the measurement of the shape of the surface of the concave portion, the distance to the step-like part of the measurement object 13 is evaluated by the value of (L₁+300−L₀).

Thereafter, similarly, the object light Ls is irradiated onto the entire surface of the measurement object 13 by moving the xy table (not shown). Consequently, information on the distance to the measurement object 13 is obtained. Thus, the surface shape of the measurement object 13 can be measured.

### Advantages of First Embodiment

According to the first embodiment, the low coherence light source 11 is used. Thus, the resolution in the depth direction is high. Each of the object light and the reference light is split into four light beams. A predetermined optical path length difference is set corresponding to each pair of the adjacent light beams of the four light beams. Thus, the step-like part, in which change in surface level is equal to or less than four times the scanning range of the optical path length scanning portion 16 (that is, equal to or less than 1200 μm in this embodiment), can be measured without changing the scanning range. Consequently, the measurement time can be reduced.

### Second Embodiment

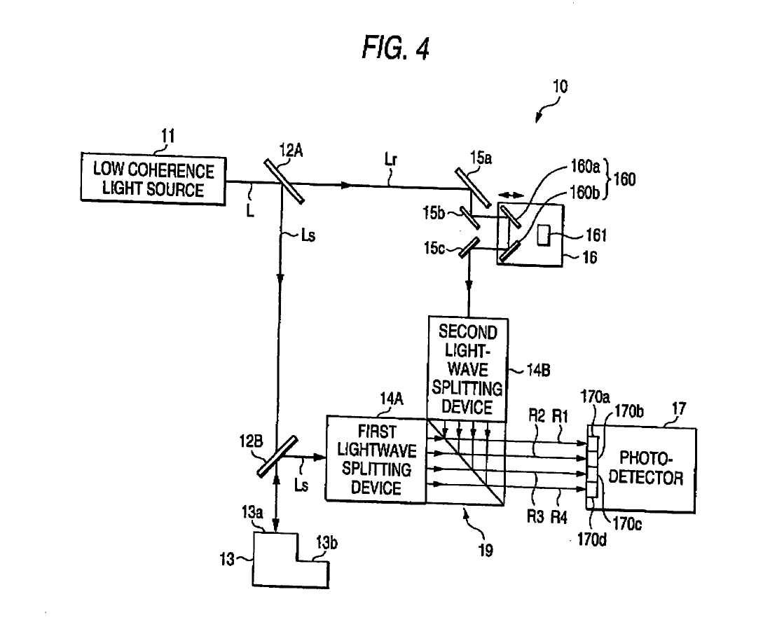

FIG. 4 shows a surface shape measuring apparatus according to a second embodiment of the invention. A surface shape measuring apparatus 10 according to this second embodiment employs a cube beam splitter 19 instead of the third beam splitter 12C of the first embodiment. This cube beam splitter 19 is formed integrally with the first and second lightwave splitting devices 14A and 14B. The rest of the second embodiment is configured similarly to that of the first embodiment.

The cube beam splitter 19 and the first and second lightwave splitting devices 14A and 14B are made of a same glass material. One of incidence end surfaces of the cube beam splitter 19 is optically bonded to an output end surface of the first lightwave splitting device 14A by an adhesive. The other incidence end surface of the cube beam splitter 19 is optically bonded to an output end surface of the second lightwave splitting device 14B by an adhesive. Thus, the cube beam splitter 19 and the first and second lightwave splitting devices 14A and 14B are formed integrally with one another. Preferably, the adhesive has a refractive index, which is nearly equal to that of a glass material, so as to reduce loss in a bonded surface.

According to this second embodiment, the lightwave splitting devices 14A and 14B are formed integrally with the cube beam splitter 19. This enables the miniaturization of the entire apparatus, and facilitates adjustment required to spatially super pose the object light beams, into which the object light is split by the first lightwave splitting device 14A, and the reference light beams, into which the reference light is split by the second lightwave splitting device 14B, with high accuracy, respectively. Additionally, cost reduction is enabled. Also, the miniaturization of the optical system reduces fluctuation of the interference signal, which is caused due to vibrations when the interference signal is obtained. Consequently, the S/N ratio at the measurement of the interference is improved.

Incidentally, in this embodiment, the lightwave splitting devices 14A and 14B are formed integrally with the cube beam splitter 19. However, the cube beam splitter 19 and the photodetector 17 can be further integrated with each other. At that time, the cube beam splitter 19 may be bonded to the photodetector 17 by an adhesive so that the combined beams obtained by respectively combining the object light beams and the reference light beams, which are outputted by the cube beam splitter 19, are irradiated onto desired places of the photodetector 17.

### Third Embodiment

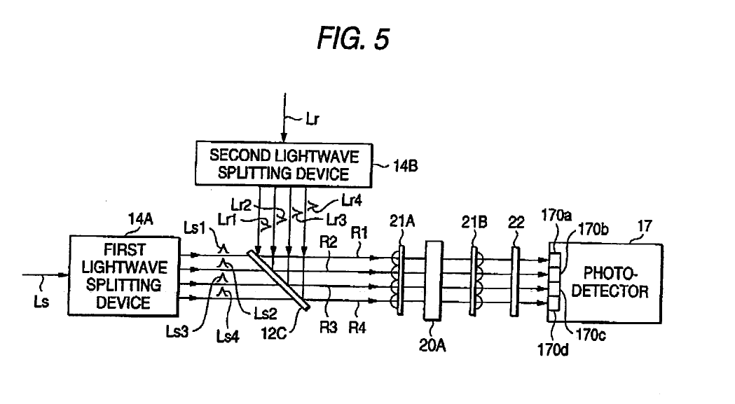

FIG. 5 shows the configuration of a part between a wave combining optical system and the photodetector of a surface shape measuring apparatus according to a third embodiment of the invention. This third embodiment employs a low coherence light source 11 adapted to output ultrashort pulses, the pulse duration of which ranges from about a picosecond to about a femtosecond, and measures a surface shape by employing an SHG (second harmonic generation) intensity auto correlation method.

This third embodiment has a wave combining optical system that comprises a nonlinear optical device 20A adapted to receive individual combined light beams from the third beam splitter 12C and to wavelength-convert the combined light beams to second harmonics (SH), a lens array 21 provided at a pre-stage of the nonlinear optical device 20A and adapted to focus the individual combined light beams, which are outputted from the third beam splitter, onto different parts of the nonlinear optical device 20A, a lens array 21B provided in a post-stage of the nonlinear optical device 20 and adapted to change focused output light beams onto the nonlinear optical device 20 into parallel light beams, and a filter 22 adapted to transmit only the second harmonics (SH). The rest of this embodiment is similar to that of the first embodiment.

The nonlinear optical device 20A generates second harmonic (SH) light when the optical path length of the object light is equal to that of the reference light. The nonlinear optical device 20A is formed of, for example, KH₂PO₄(KDP), βBaB₂O₄(BBO), or LiB₃O₅(LBO). Incidentally, it is preferable to use a nonlinear optical crystal, whose crystal face is cut according to the wavelength of the used light source and to phase-matching conditions.

This third embodiment uses ultrashort pulses, the pulse duration of each of which ranges from a picosecond to a femtosecond. Thus, the surface shape of the measurement object can be measured with high resolution. Also, The intensity of the ultrashort pulse is high, so that the correlation measurement utilizing nonlinear optical effects is facilitated. According to the correlation measurement utilizing the nonlinear optical effects, the intensity of the correlation signal between the object light and the reference light is measured, differently from interference measurement. Thus, influence of phase information on the phase of a light pulse is eliminated. Consequently, influence of mechanical vibrations is reduced. Further, because the filter 22 adapted to transmit only SH-light is disposed at the pre-stage of the photodetector 17, the S/N ratio can be improved in the shape measurement.

It is desirable that the polarizing directions of the object light and the reference light are adjusted so that the phase matching conditions are met. For example, to satisfy Type I phase matching condition, the polarizing directions of the object light and the reference light are set to be parallel to each other. To satisfy Type II phase matching condition, the polarizing directions of the object light and the reference light are set to be orthogonal to each other. Consequently, SH-light can efficiently be generated.

### Fourth Embodiment

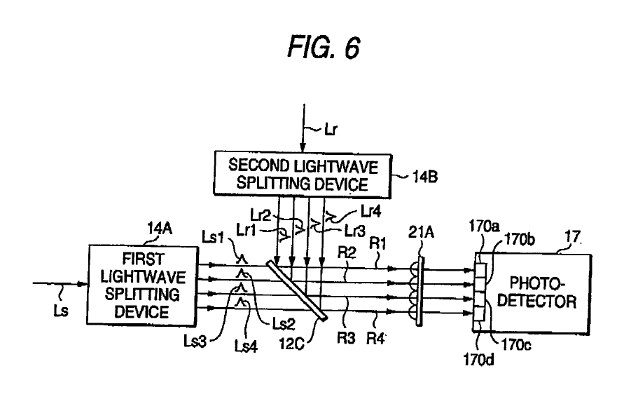

FIG. 6 shows the configuration of a part between a wave combining optical system and the photodetector of a surface shape measuring apparatus according to a fourth embodiment of the invention. This fourth embodiment employs a low coherence light source 11 adapted to output ultrashort pulses, the pulse duration of which ranges from about a picosecond to about a femtosecond, and measures a surface shape by utilizing two-photon absorption.

In this fourth embodiment, each of the photoelectric conversion devices 170a to 170d is constituted by using a photodiode that has a band gap in the vicinity of a level, which is twice the photon energy of light generated from the used light source 11. A lens array 21B is disposed at the pre-stage of the photodetector 17.

The photodiode constituting each of the photoelectric conversion devices 170a to 170d outputs strong two-photon optical-beam-induced electric current by two-photon absorption that occurs when the optical path length of the object light is equal to that of the reference light. Further, ZnSe, GaAsP, Si or the like may be used as the material of the photodiode.

According to this fourth embodiment, the photodiode serves a device, which generates a correlation signal, and a photoelectric conversion device. Thus, the configuration of the optical system is simplified. For example, when a surface light receiving device, such as Si-CCD camera, is used, the necessity for arranging photo diodes like an array is eliminated. Thus, the miniaturization of the entire apparatus, and the simplification of adjustment of the optical system are enabled.

Incidentally, a correlation signal, which represents the correlation between the object light and the reference light, can be measured by using a photodiode instead of the nonlinear optical device used in the SHG intensity auto correlation method.

### Fifth Embodiment

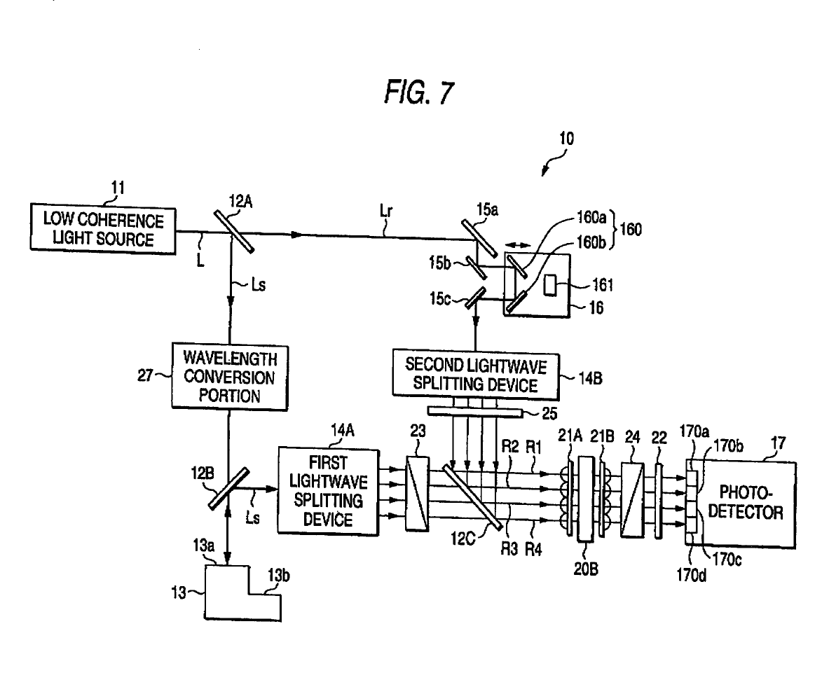

FIG. 7 shows a surface shape measuring apparatus according to a fifth embodiment of the invention. This fifth embodiment employs a low coherence light source 11 adapted to output ultra short pulses, the pulse duration of which ranges from about a picosecond to about a femtosecond, and measures a surface shape by utilizing Kerr shutter.

This fifth embodiment is configured as follows. That is, in the third embodiment, a wavelength conversion portion 27 adapted to convert the wavelength of the object light Ls is disposed between the first and second beam splitters 12A and 12B. The fifth embodiment further comprises a polarizer 23 disposed between the first lightwave splitting device 14A and the third beam splitter 12C and adapted to convert the object light beams Ls1 to Ls4 outputted from the first lightwave splitting device 14A to linearly polarized light, and an analyzer 24 disposed at the post-stage of the nonlinear optical device 20B so that the polarization axis thereof is orthogonal to the polarization axis of the polarizer 23, as a wave combining system. A half-wavelength plate 25 adapted to incline the polarization direction of the reference light beams Lr1 to Lr4, which are outputted from the second lightwave splitting device 14B, to the polarization direction of the polarizer 23 by 45 degrees is disposed immediately posterior to the second lightwave splitting device 14B. This embodiment further employs an optical switch adapted to change the polarization state of the object light when the object light and the reference light are simultaneously incident on the nonlinear optical device 20B and also adapted to cause the object light to be transmitted through the analyzer 24. The rest of the fifth embodiment is similar to that of the third embodiment. Incidentally, the Kerr shutter comprises the nonlinear optical device 20, the polarizer 23, and the analyzer 24.

Nonlinear Optical Device

It is desirable that the nonlinear optical device 20B employed in the Kerr shutter is of the surface type, and has practically preferable nonlinear optical characteristics, that the opened time of the shutter is short and is substantially equal to the pulse duration of a used light pulse, and that the nonlinear optical device 20B is chemically, thermally, and optically stable. From the aforementioned viewpoint, for instance, a dye aggregate thin film comprising a squarylium J-aggregate disclosed in JP-A-11-282034, and a dye aggregate thin film comprising a squarylium dye causing change in optical characteristics due to two-photon absorption, which is disclosed in JP-A-2000-314901, can be used as the nonlinear optical device 20B. Additionally, semiconductors, such as Si, GaAs, ZnSe, and CdTe, a phthalocyanine dye, π-conjugated polymers, such as polydiacetylene and polythiophene, and thin film made of fullerene C60 or C70 can be used as the material of an optical switch enabled to make a rapid response.

### Operation of Fifth Embodiment

Next, an operation of this fifth embodiment is described hereinbelow. The object light beams Ls1 to Ls4, into which the object light is split by the first lightwave splitting device 14A, are converted into linearly polarized light beams by the polarizer 23. Subsequently, the linearly polarized light beams are transmitted through the third beams splitter 12C and focused onto the nonlinear optical device 20 by the lens array 21A. On the other hand, the polarization direction of the reference light beams Lr1 to Lr4, into which the reference light is split by the second lightwave splitting device 14B, is inclined by the half-wavelength plate 25. Then, the reference light beams Lr1 to Lr4 are reflected by the third beam splitter 12C. Subsequently, the reflected light beams are focused by the lens array 21A onto the irradiation positions, onto which the object light beams Ls1 to Ls4 are irradiated, on the nonlinear optical device 20. Thereafter, the object light beams Ls1 to Ls4 are changed back to the parallel light beams by the lens array 21B. Subsequently, these parallel light beams are introduced to the analyzer 24.

When the timing, with which the object light beams are incident on the nonlinear optical device 20, differs from the timing, with which the reference light beams are incident on the nonlinear optical device 20, anisotropy is not induced in the nonlinear optical device 20. Thus, the object light beams are not transmitted through the analyzer 24. When the reference light beams, which are linearly polarized light beams, whose polarization direction is inclined to that of the object light beams about 45 degrees, are incident on the nonlinear optical device 20 simultaneously with the object light beams, anisotropy is induced in the nonlinear optical device 20. The polarization state of the object light beams are changed and transmitted through the analyzer 24. The object light beams transmitted through the analyzer 24 are incident on the photodetector 17 through the filter 22 that transmits only the object light beams.

The transmittance of the Kerr shutter is maximized when the optical path length of the object light is equal to that of the reference light. Thus, a correlation signal, which represents the correlation between the object light and the reference light, can be obtained by measuring an intensity of each of the object light beams Ls1 to Ls4 transmitted through the Kerr shutter by the photodetector 17.

### Advantages of Fifth Embodiment

This fifth embodiment uses ultrashort pulses whose time duration is in the picosecond and femtosecond regimes. Also, the Kerr shutter makes a rapid response, as compared with an electrical shutter. Consequently, the surface shape can be measured with high resolution.

Incidentally, in the aforementioned configuration, the polarizer 23 and the half-wavelength plate 25 are respectively placed immediately posterior to the lightwave splitting devices 14A and 14B, respectively. However, the polarizer 23 and the half-wavelength plate 25 may be respectively placed immediately prior to the lightwave splitting devices 14A and 14B, respectively.

In this embodiment, the reference light beams can always be transmitted by the analyzer 24. Thus, the background level of the photodetector 17 is increased. The S/N ratio is degraded. Thus, it is desirable that the wavelength of the object light or the reference light is converted, and that the filter 22 adapted to transmit only the object light beams is disposed at the pre-stage of the photodetector 17. The wavelength conversion portion 27 utilizes Raman amplification of an optical fiber or the generation of harmonic waves by a nonlinear crystal. At that time, a dichroic mirror, which has a high reflectance against the wavelength of the reference light beams and also has a high transmittance against the wavelength of the object light beams, can be used instead of the beam splitter 12C. Consequently, the utilization efficiencies of the object light and the reference light can be enhanced.

### Sixth Embodiment

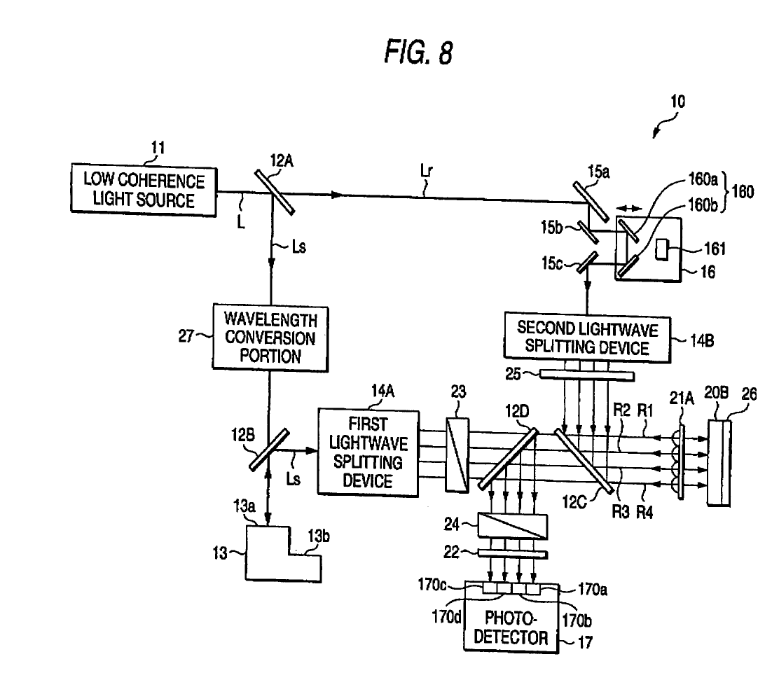

FIG. 8 shows a surface shape measuring apparatus according to a sixth embodiment of the invention. This sixth embodiment employs a transmission Kerr shutter, differently from the fifth embodiment employing a reflection Kerr shutter. The sixth embodiment has a reflection layer 26 provided on the back surface of the nonlinear optical device 20B, which is used for reflecting incident object light. Also, a fourth beam splitter 12D is disposed between the polarizer 23 and the third beam splitter 12C. Light reflected by the reflection layer 26 of the nonlinear optical device 20B is reflected by the fourth beam splitter 12D. This reflected light is detected by the photodetector 17 through the analyzer 24 and the filter 22. The rest of the sixth embodiment is similar to that of the fifth embodiment.

With this configuration, the object light beams Ls1 to Ls4 focused by the lens array 21A are reflected by the reflection layer 26 provided on the back surface of the nonlinear optical device 20B. Thus, the object light beams Ls1 to Ls4 are returned to the lens array 21A, and are changed to parallel light beams. Subsequently, the object light beams Ls1 to Ls4 are transmitted through the third beam splitter 12C and are reflected by the fourth beam splitter 12D. Then, the changed portions of the polarization states of the reflected object light beams can be transmitted through the analyzer 24 and introduced into the photodetector 17.

According to this sixth embodiment, the object light beams Ls1 to Ls4 reciprocatively travel in the nonlinear optical device 20B. Thus, the nonlinear optical device 20B is effectively elongated. The switching efficiency of the Kerr shutter can be enhanced. Both the focusing of the combined light beams and the conversion of the combined light beams into parallel light beams can be achieved only by one lens array 21A. Consequently, the simplification and the miniaturization of the optical system, and the reduction of an adjustment time are enabled. Further, the polarization direction of the object light beams is set to be that of the P-polarized light. The polarization beam splitter is used instead of the beam splitter 12D. Thus, when the object light beams are irradiated to the nonlinear optical device, and when only the component, whose polarization state is changed, is taken out of the object light beams reflected by the nonlinear optical device, the loss can be reduced.

### Seventh Embodiment

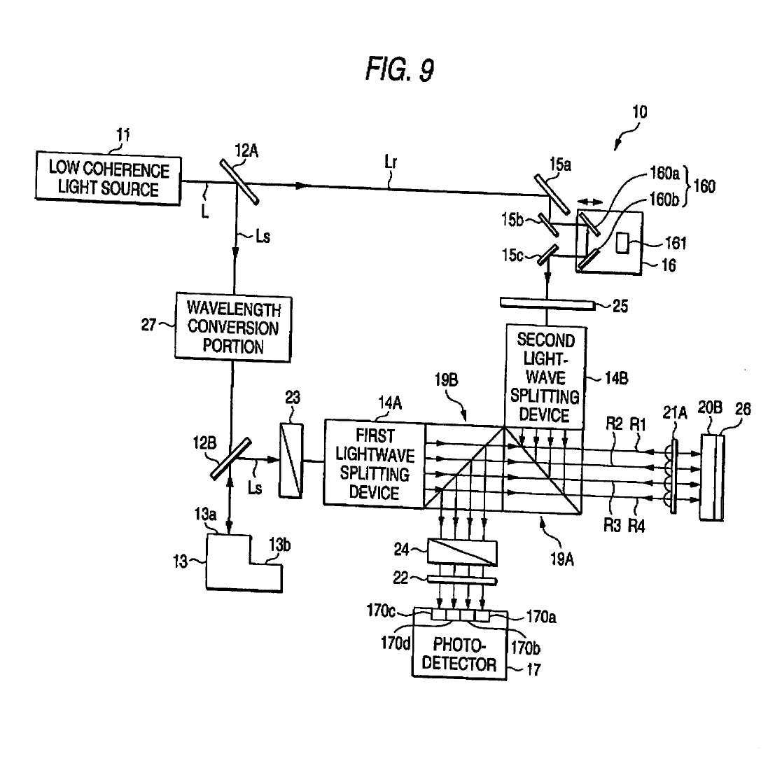

FIG. 9 shows a surface shape measuring apparatus according to a seventh embodiment of the invention. This seventh embodiment is configured by integrating the reflection Kerr shutter, similarly to the second embodiment shown in FIG. 4. The seventh embodiment employs the first and second cube beam splitters 19A and 19B, instead of the plate type third and fourth beam splitters 12C and 12D shown in FIG. 8. The first lightwave splitting device 14A, the second cube beam splitter 19B, the second lightwave splitting device 14B, and the first cube beam splitter 19A are integrated by being optically bonded to one another by an adhesive.

### Advantages of Seventh Embodiment

According to this seventh embodiment, the first and second lightwave splitting devices 14A and 14B, and the first and second beam splitters 19A and 19B are formed integrally with one another. This enables the miniaturization of the entire apparatus, and facilitates adjustment required to spatially superpose the object light beams, into which the object light is split by the first lightwave splitting device 14A, and the reference light beams, into which the reference light is split by the second lightwave splitting device 14B, with high accuracy, respectively. Additionally, cost reduction is enabled.

Incidentally, in this embodiment, only the first and second lightwave splitting devices 14A and 14B, and the first and second beam splitters 19A and 19B are formed integrally with one another. Moreover, the lens array and the nonlinear optical device 20B are also formed integrally with such devices and the beam splitters. Consequently, the size of the apparatus can be further reduced.

### Eighth Embodiment

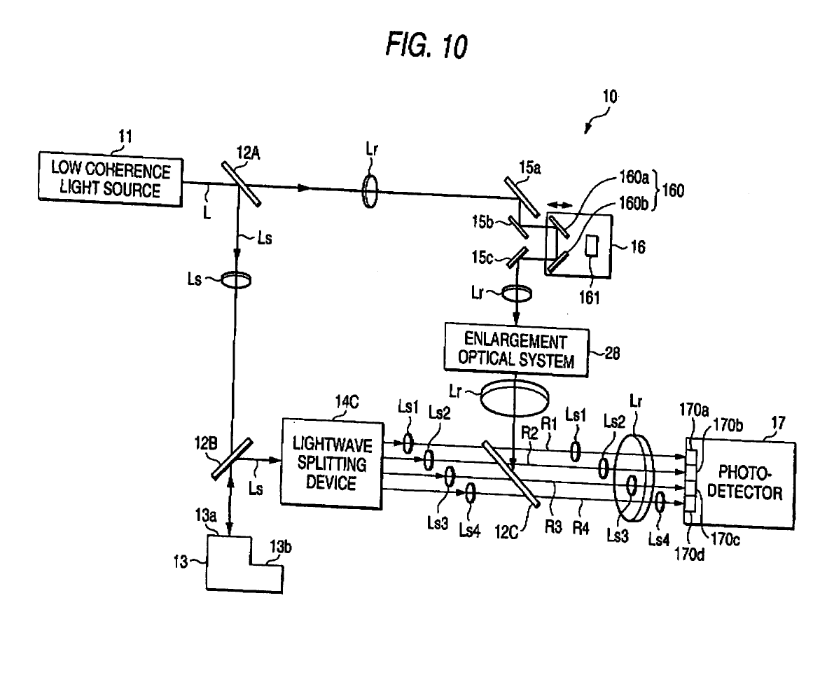

FIG. 10 shows a surface shape measuring apparatus according to a seventh embodiment of the invention. Although the first and second lightwave splitting devices 14A and 14B are disposed on the optical paths of the object light Ls, which is reflected from the measurement object 13, and the reference light Lr in the first embodiment, the lightwave splitting device 14C is disposed only on the optical path of the object light Ls reflected from the measurement object 13 in this eighth embodiment. Also, an enlargement optical system 28 adapted to enlarge the beam diameter of the reference light Lr is disposed at the pre-stage of the third beam splitter 12C.

The lightwave splitting device 14C is adapted to split the object light Ls coming from the measurement object 13 into plural object light beams Ls and to give a predetermined optical path length difference to between each pair of adjacent two of the plural object light beams Ls. This lightwave splitting device 14C is configured, similarly to the second lightwave splitting device 14B of the first embodiment.

Light Receiving Operation

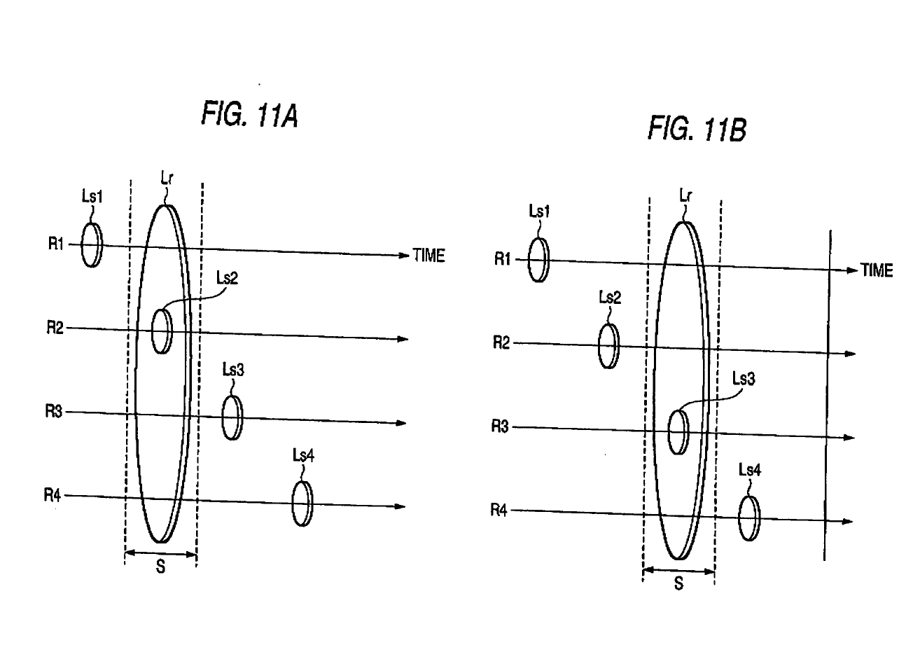

FIGS. 11A and 11B are timing charts showing timing with which each of plural object light beams and a single reference light beam combined by the third beam splitter 12C is received in the eighth embodiment. Incidentally, in these figures, reference character S designates a scanning range in which the optical path scanning portion 16 scans.

An optical path length difference corresponding to a time of 1 ps is given to between each pair of adjacent optical paths of the fourth optical paths respectively corresponding to the four object light beams Ls1 to Ls4, into which the object light is split by the lightwave splitting device 14C, in the lightwave splitting device 14C. The four object light beams Ls1 to Ls4 propagate thereon with different timings, respectively, and are incident on the photodetector 17.

On the other hand, the reference light Lr is incident on the photodetector 17 by being enlarged so that an enlarged optical beam thereof includes four object light beams Ls1 to Ls4 propagating on the four optical paths R1 to R4, respectively.

Therefore, in a case where the surface region (1) 13a of the convex portion of the measurement object 13 is measured by using the object light Ls, as shown in FIG. 11A, and where interference occurs only on the second optical path R2 among the four optical paths, only the photoelectric conversion device 170b of the photodetector 17, which corresponds to the second optical path R2, outputs an interference signal.

In a case where the object light Ls is irradiated onto the surface region (2) 13b of the concave portion of the measurement object 13, the optical path length of the object light is increased, so that a time taken by the object light to reach the photodetector is increased. At that time, in a case where the unevenness of the surface of the measurement object 13 is large, and where the depth of the concave portion is equal to or larger than twice the scanning range “S” of the optical path length scanning portion 16, no interference signal is produced by the photoelectric conversion device corresponding to the second optical path R2, and instead, the photoelectric conversion device 170c corresponding to the third optical path R3 outputs an interference signal, as shown in FIG. 11B.

Although this eighth embodiment is inferior to the first embodiment in light utilizing efficiency, the resolution in the depth direction is high, similarly to the first embodiment. Thus, the step-like part, in which change in surface level is equal to or less than four times the scanning range of the optical path length scanning portion 16, can be measured without changing the scanning range. Consequently, the measurement time can be reduced.

### Other Embodiments

Incidentally, the invention is not limited to the aforementioned embodiments. Various modifications can be made without departing from the spirit and scope of the invention. For example, the composing elements of the embodiments of the invention can optionally be combined with one another without departing from the spirit and scope of the invention.

The second beams splitter 12B is used in the first to eighth embodiments when the object light 3c reflected and returned from the measurement object 13 is introduced to the lightwave splitting device 14A. However, in this case, due to the loss only in the beam splitter 12B, an amount of the object light 3c is reduced to (¼). Thus, a polarization beam splitter is used in stead of the beam splitter 12B. Also, a quarter-wavelength plate is disposed between the polarization beam splitter and the measurement object 13. Consequently, the loss can be decreased.

Further, although the number of light beams, into which the object or reference light is split by each of the lightwave splitting devices 14A, 14B, and 14C, is 4 in the first to eighth embodiments, the number of such light beams is not limited thereto. The object or reference light may be split into, for instance, 16 light beams.

In a case where the object light is irradiated onto the measurement object, object light focused by using a lens so as to increase the resolution of the surface of the measurement object may be irradiated onto the measurement object.

Although the optical path length scanning portion 16 is disposed on the optical path of the reference light in the first to eighth embodiments, similar advantages can be obtained by disposing the optical path length scanning portion 16 on the optical path of the object light.

What is claimed is:

1. A surface shape measuring apparatus adapted so that object light and reference light are outputted from a same low coherence light source, that after the object light which is irradiated onto a measurement object and is reflected and returned therefrom is combined with the reference light, and combined light is received by a photodetector to thereby measure a surface shape of the measurement object, the surface shape measuring apparatus comprising:
an optical path length scanning portion adapted to scan an optical path length of the object light or the reference light within a predetermined range; and
a splitting optical system provided on at least one of optical paths of the object light which comes from the measurement object and the reference light, to split an incident light beam which is incident thereon into plural light beams, wherein
the splitting optical system sets a predetermined optical path length difference corresponding to each predetermined pair of the light beams among the plural light beams into which the incident light beam is split.

2. The surface shape measuring apparatus according to claim 1, further comprising:
a pair of the splitting optical systems provided on both optical paths of the object light, which comes from the measurement object,.and the reference light, wherein
one of the pair of splitting optical systems sets a predetermined optical path length difference corresponding to each predetermined pair of the light beams among the plural light beams into which the incident light beam is split.

3. The surface shape measuring apparatus according to claim 1, wherein:
the splitting optical system includes:
an incidence surface and an output surface, which are parallel to each other;
plural parallel transparent plates stacked and inclined to each of the incidence surface and the output surface 45 degrees; and
a beam splitter surface and a reflection surface, which are formed at predetermined places on stacked surfaces that are provided among the plural parallel transparent plates.

4. The surface shape measuring apparatus according to claim 3, wherein
the one of the pair of splitting optical systems sets the predetermined optical path length difference corresponding to each predetermined pair of the light beams among the plural light beams by adjusting thicknesses of the plural parallel transparent plates.

5. The surface shape measuring apparatus according to claim 3, wherein
the optical system is formed integrally with the combining optical system.

6. The surface shape measuring apparatus according to claim 1, wherein:
the photodetector has plural photoelectric conversion devices of the number corresponding to the number of the light beams, into which the incident light beam is split by the splitting optical system; and
each of the plural photoelectric conversion devices converts the combined light, which is received by the photodetector, into an electrical signal corresponding to the optical path length difference between the object light and the reference light.

7. The surface shape measuring apparatus according to claim 1, wherein
the photodetector outputs an interference signal corresponding to an interference intensity, when the object light interferes with the reference light.

8. The surface shape measuring apparatus according to claim 1, wherein
the coherence light source is a pulsed light source adapted to output a light pulse.

9. The surface shape measuring apparatus according to claim 8, wherein
the photodetector outputs a correlation signal corresponding to the optical path length difference between the object light and the reference light.

10. The surface shape measuring apparatus according to claim 8, wherein
the combining optical system has a nonlinear optical device adapted to wavelength-convert the combined light to a second harmonic and also adapted to cause the second harmonic to be incident on the photodetector.

11. The surface shape measuring apparatus according to claim 8, wherein
the photodetector outputs a two-photon induced electric current obtained by being excited by two-photon absorption.

12. The surface shape measuring apparatus according to claim 8, wherein
the combining optical system has a Kerr shutter adapted to open in response to the reference light to thereby cause the object light to be incident on the photodetector.
